(19) United States
(12) Patent Application Publication
(10) Pub. No.: US 2025/0069133 A1
(43) Pub. Date: Feb. 27, 2025

(54) SYSTEM AND METHOD FOR COLLECTING ASSET OR REAL ESTATE DATA, AND REAL-TIME MATCHING OF SALE OFFERS AND PURCHASE OFFERS POSSIBILITY

(71) Applicant: Udomsuk LIMWONGTHONG, Bangkok (TH)

(72) Inventor: Udomsuk LIMWONGTHONG, Bangkok (TH)

(21) Appl. No.: 18/718,820

(22) PCT Filed: Feb. 16, 2023
(86) PCT No.: PCT/TH2023/000001

§ 371 Date: Jun. 12, 2024

(30) Foreign Application Priority Data
Feb. 17, 2022 (TH) 2203000427

(51) Int. Cl. G06Q 30/08; G06Q 50/16; G06Q 50/18

(52) U.S. Cl. CPC G06Q 30/08; G06Q 50/16; G06Q 50/18

(57) ABSTRACT

A system and method for collecting asset or real estate data and real-time matching of sale offers and purchase offers possibility comprises an input of Sale-Offer Data of assets or real estate offered for sale, an input of Purchase-Offer Data of assets or real estate desired for acquisition, and a Central Processing Unit. Upon receiving Sale-Offer Data and Purchase-Offer Data, the Central Processing Unit will compare the two and match them if there is a possible match. The data is then processed and analyzed to assess the possibility of a match between identical or similar offers. Then, the Central Processing Unit will notify the sale offeror through the First Electronic Device and the purchase offeror through the Second Electronic Device of a list of potential matches. The parties can then confirm the matches, which will then create a trading transaction.

### TECHNICAL FIELD

This invention is in the field of computer engineering and computer science, particularly a system and method for collecting asset or real estate data and real-time matching of sale offers and purchase offers possibility.

### BACKGROUND ART

Previously, trading in assets or real estate required reviewing online listings, making telephone inquiries, or visiting properties in person, which was inconvenient as it required constant monitoring of potential buyers/sellers. Moreover, buyers were unable to specify their requirements, making it challenging to filter and match sale offers and purchase offers online in real time. After matching sale and purchase offers, registration of ownership transfer at the Department of Lands will be the final stage.

### SUMMARY OF INVENTION

A system and method for collecting asset or real estate data and real-time matching of sale offers and purchase offers possibility comprises an input of Sale-Offer Data of assets or real estate offered for sale, an input of Purchase-Offer Data of assets or real estate desired for acquisition, and a Central Processing Unit. Upon receiving Sale-Offer Data and Purchase-Offer Data, the Central Processing Unit will compare the two and match them if there is a possible match. The data is then processed and analyzed to assess the possibility of a match between identical or similar offers. Then, the Central Processing Unit will notify the sale offeror through the First Electronic Device and the purchase offeror through the Second Electronic Device of a list of potential matches. The parties can then confirm the matches, which will then create a transaction.

This invention aims to provide a system and method for collecting asset or real estate data and real-time matching of sale offers and purchase offers possibility to make the trading of assets or real estate easier, faster, more convenient, and more safety, enabling trading decisions to be made through an online system in real time.

### DETAILED DESCRIPTION OF INVENTION

Components of a system and method for collecting asset or real estate data and real-time matching of sale offers and purchase offers possibility comprise:

an input of the Sale-Offer Data (10) that is an asset or real estate offered for sale, wherein the input of the Sale-Offer Data (10) will be imported by at least one of the First Electronic Devices (11) such as smartphones, computers, tablets, etc.,
A. The Sale-Offer Data (10) can be inputted by such category as house, condominium, factory, commercial building, land, warehouse, townhouse, hotel, or dormitory, including location, sale offer price, size of real estate, and other data.

The Sale-Offer Data (10) comprises of multiple Sale-Offer Data such as the First Sale-Offer Data (101), the Second Sale-Offer Data (102), the Third Sale-Offer Data (103), and other Sale-Offer Data (104), etc.,

wherein at least one of the First Electronic Devices (11) will import Sale-Offer Data wirelessly to the Central Processing Unit (30),

an input of the Purchase-Offer Data (40) that is a purchase offer of assets or real estate desired for acquisition, wherein the input of the Purchase-Offer Data (40) will be imported by at least one of the Second Electronic Devices (41) such as smartphones, computers, tablets, etc.,

B. The Purchase-Offer Data (40) can be inputted by such category as house, condominium, factory, commercial building, land, warehouse, townhouse, hotel, or dormitory, including location, purchase offer price, size of real estate, and other data.

The Purchase-Offer Data (40) comprises of multiple Purchase-Offer Data such as the First Purchase-Offer Data (401), the Second Purchase-Offer Data (402), the Third Purchase-Offer Data (403), and other Purchase-Offer Data (404), etc.,

wherein at least one of the Second Electronic Devices (41) will import the Purchase-Offer Data wirelessly to the Central Processing Unit (30),

the Central Processing Unit (30), when receiving the First Sale-Offer Data (101), the Second Sale-Offer Data (102), the Third Sale-Offer Data (103), and other Sale-Offer Data (104), including the First Purchase-Offer Data (401), the Second Purchase-Offer Data (402), the Third Purchase-Offer Data (403), and other Purchase-Offer Data (404),

the Central Processing Unit (30) will match the First Sale-Offer Data (101), the Second Sale-Offer Data (102), the Third Sale-Offer Data (103), and the other Sale-Offer Data (104), with the First Purchase-Offer Data (401), the Second Purchase-Offer Data (402), the Third Purchase-Offer Data (403), and the other Purchase-Offer Data (404) that have a possible match or similarity between sale offers and purchase offers, wherein the Central Processing Unit (30) will match identical or similar details from the following:
A. The Sale-Offer Data (10) that is inputted by such category as house, condominium, factory, commercial building, land, warehouse, townhouse, hotel, or dormitory, including location, sale offer price, size of real estate, and other data.
B. The Purchase-Offer Data (40) that is inputted by such category as house, condominium, factory, commercial building, land, warehouse, townhouse, hotel, or dormitory, including location, purchase offer price, size of real estate, and other data.

Then, the data will be processed (30) and distinguished the possibility between the Sale-Offer Data (10) and the Purchase-Offer Data (40) that are identical or similar in A. and B., by estimation as follows:
A. The sale offer and purchase offer are identical or similar to 90-100%, it is considered of having possibility at Level S.
B. The sale offer and purchase offer are identical or similar to 80-89%, it is considered of having possibility at Level A.
C. The sale offer and purchase offer are identical or similar to 70-79%, it is considered of having possibility at Level B.
D. The sale offer and purchase offer are identical or similar to 60-69%, it is considered of having possibility at Level C.
E. The sale offer and purchase offer are identical or similar to 50-59%, it is considered of having possibility at Level D.

The Central Processing Unit (30) will notify the sale offers in a sequence of possibilities according to A, B, C, D, E wirelessly to at least one of the Second Electronic Devices (41) to report the possibility and asset or real estate data.

The purchase offeror will compare and choose any one of A, B, C, D, E, or combination thereof from at least one of the Second Electronic Devices (41) that are selected from an input of the First Purchase-Offer Data (401), the Second Purchase-Offer Data (402), the Third Purchase-Offer Data (403), and other Purchase-Offer Data (404), respectively, and the purchase offeror will send the purchase offer to the Central Processing Unit (30). The Central Processing Unit (30), when receiving Purchase-Offer Data from input of the First Purchase-Offer Data (401), the Second Purchase-Offer Data (402), the Third Purchase-Offer Data (403), and the other Purchase-Offer Data (404), respectively, will then send the data to at least one of the First Electronic Devices (11) that are selected from the input of the First Sale-Offer Data (101), the Second Sale-Offer Data (102), and the Third Sale-Offer Data (103), and the other Sale-Offer Data (104), respectively, using data according to A, B, C, D, E as part of the decision-making process.

At least one of the First Electronic Device (11) receives Purchase-Offer Data from the input of the First Purchase-Offer Data (401), the Second Purchase-Offer Data (402), the Third Purchase-Offer Data (403), and other Purchase-Offer Data (404), respectively, by selecting from any one of A, B, C, D, E, or combination thereof as part of the decision-making process. The First Electronic Device (11) will send sale offer that can be selected from input of the First Sale-Offer Data (101), the Second Sale-Offer Data (102), and the Third Sale-Offer Data (103), and other Sale-Offer Data (104), respectively, to the Central Processing Unit (30). The Central Processing Unit (30), when receiving the First Sale-Offer Data (101), the Second Sale-Offer Data (102), and the Third Sale-Offer Data (103), and other Sale-Offer Data (104), respectively, will forward data to at least one of the Second Electronic Device (41) that can be selected from input of the First Purchase-Offer Data (401), the Second Purchase-Offer Data (402), the Third Purchase-Offer Data (403), and other Purchase-Offer Data (404), respectively.

The First Sale-Offer Data (101), the Second Sale-Offer Data (102), and the Third Sale-Offer Data (103), and the other Sale-Offer Data (104), respectively, and the First Purchase-Offer Data (401), the Second Purchase-Offer Data (402), the Third Purchase-Offer Data (403), and the other Purchase-Offer Data (404), respectively, that communicate with each other via the First Electronic Device (11), the Central Processing Unit (30), and the Second Electronic Device (41) will confirm the matched offers, creating the first step of transaction (1).

Next, the First Electronic Device (11) and the Second Electronic Device (41) will send data to each other and communicate with each other to ask for more details, and price negotiation, creating the second step of transaction (2).

Then, the next step, the Second Electronic Device (41) will transfer deposit through the website operating system and application realized by the Central Processing Unit (30), creating the third step of transaction (3).

Then, the next step, the First Electronic Device (11) and the Second Electronic Device (41) will send data to each other and communicate with each other to find an agency (50) to inspect asset or real estate, creating the fourth step of transaction (4).

Next, the selected agency (50) will be notified that they are selected as the agency to valuate and inspect asset or real estate by sending data from the Central Processing Unit (30) to the Third Electronic Device (51), creating the fifth step of transaction (5).

Then, the agency (50) will coordinate with the purchase offeror (42) and the sale offeror (12) via the Third Electronic Device (51) to manage legal documents and register with the Land Office and manage payment between sale offeror and purchase offeror, creating the sixth step of transaction (6).

### BRIEF DESCRIPTION OF DRAWINGS

FIG. 1 shows the components of a system and method for collecting asset or real estate data and real-time matching of sale offers and purchase offers possibility according to this invention.

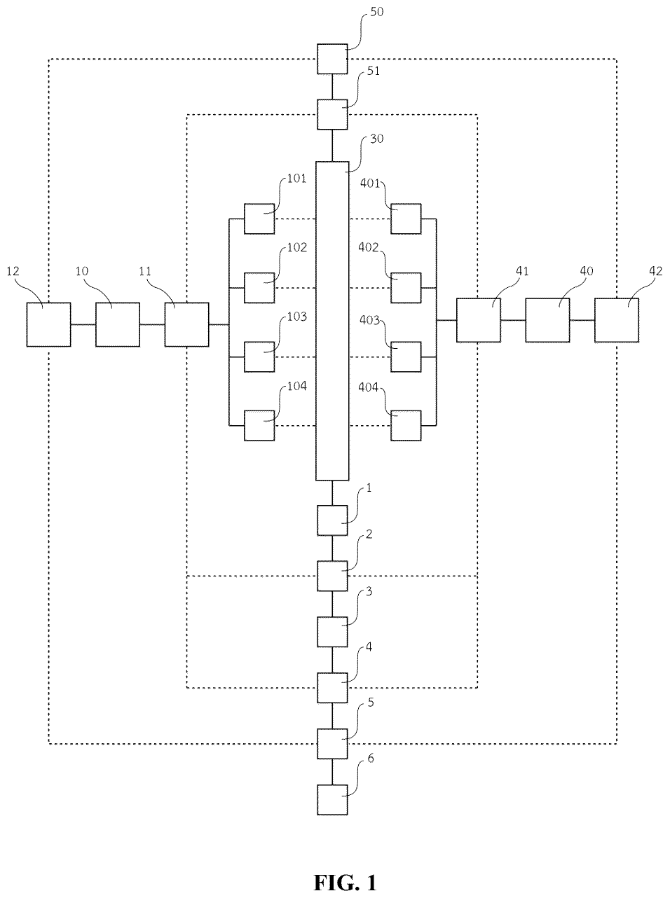

### BEST MODE FOR CARRYING OUT THE INVENTION

As described in the Detailed Description of Invention.

What is claimed is:

1-2. (canceled)

3. A system and method for collecting asset or real estate data and real-time matching of sale offers and purchase offers possibility, comprising:
an input of the Sale-Offer Data (10), which is an asset or real estate offered for sale, wherein the input of the Sale-Offer Data (10) will be imported by at least one of the First Electronic Devices (11) such as smartphones, computers, tablets, etc.
A. The Sale-Offer Data (10) can be inputted by such category as house, condominium, factory, commercial building, land, warehouse, townhouse, hotel, or dormitory, including location, sale offer price, size of real estate, and other data.
The Sale-Offer Data (10) comprises of multiple Sale-Offer Data such as the First Sale-Offer Data (101), the Second Sale-Offer Data (102), the Third Sale-Offer Data (103), and other Sale-Offer Data (104), etc.,
wherein at least one of the First Electronic Devices (11) will import Sale-Offer Data wirelessly to a Central Processing Unit (30),
an input of the Purchase-Offer Data (40), which is an asset or real estate desired for acquisition, wherein the input of the Purchase-Offer Data (40) will be imported by at least one of Second Electronic Devices (41) such as smartphones, computers, tablets, etc.,
B. The Purchase-Offer Data (40) can be inputted by such category as house, condominium, factory, commercial building, land, warehouse, townhouse, hotel, or dormitory, including location, sale offer price, size of real estate, and other data.
The Purchase-Offer Data (40) comprises of multiple Purchase-Offer Data such as the First Purchase-Offer Data (401), the Second Purchase-Offer Data (402), the Third Purchase-Offer Data (403), and other Purchase-Offer Data (404), etc.,
wherein at least one of the Second Electronic Devices (41) will import the Purchase-Offer Data wirelessly to the Central Processing Unit (30),
Characterized in that
the Central Processing Unit (30), when receiving the First Sale-Offer Data (101), the Second Sale-Offer Data (102), the Third Sale-Offer Data (103), and other Sale-Offer Data (104), including the First Purchase-Offer Data (401), the Second Purchase-Offer Data (402), the Third Purchase-Offer Data (403), and other Purchase-Offer Data (404),
the Central Processing Unit (30) will match the First Sale-Offer Data (101), the Second Sale-Offer Data (102), the Third Sale-Offer Data (103), and the other Sale-Offer Data (104), with the First Purchase-Offer Data (401), the Second Purchase-Offer Data (402), the Third Purchase-Offer Data (403), and the other Purchase-Offer Data (404) that have a possible match or similarity between sale offers and purchase offers, wherein the Central Processing Unit (30) will match identical or similar details from the following:
A. The Sale-Offer Data (10) is inputted by such category as house, condominium, factory, commercial building, land, warehouse, townhouse, hotel, or dormitory, including location, sale offer price, size of real estate, and other data.
B. The Purchase-Offer Data (40) is inputted by such category as house, condominium, factory, commercial building, land, warehouse, townhouse, hotel, or dormitory, including location, sale offer price, size of real estate, and other data.
Then, the data is processed (30) and distinguished the possibility between the Sale-Offer Data (10) and the Purchase-Offer Data (40) that are identical or similar in A. and B., by estimation as follows:
A. The sale offer and purchase offer are identical or similar to 90-100%, it is considered of having possibility at Level S.
B. The sale offer and purchase offer are identical or similar to 80-89%, it is considered of having possibility at Level A.
C. The sale offer and purchase offer are identical or similar to 70-79%, it is considered of having possibility at Level B.
D. The sale offer and purchase offer are identical or similar to 60-69%, it is considered of having possibility at Level C.
E. The sale offer and purchase offer are identical or similar to 50-59%, it is considered of having possibility at Level D.
The Central Processing Unit (30) will notify the sale offers in a sequence of possibilities according to A, B, C, D, E wirelessly to at least one of the Second Electronic Devices (41) to report the possibility and asset or real estate data
The purchase offeror will compare and choose any one of A, B, C, D, E, or combination thereof from at least one of the Second Electronic Devices (41) that are selected from an input of the First Purchase-Offer Data (401), the Second Purchase-Offer Data (402), the Third Purchase-Offer Data (403), and the other Purchase-Offer Data (404), respectively, and the purchase offeror will send the purchase offer to the Central Processing Unit (30). The Central Processing Unit (30), when receiving Purchase-Offer Data from input of the First Purchase-Offer Data (401), the Second Purchase-Offer Data (402), the Third Purchase-Offer Data (403), and the other Purchase-Offer Data (404), respectively, will then send the data to at least one of the First Electronic Devices (11) that are selected from the input of the First Sale-Offer Data (101), the Second Sale-Offer Data (102), and the Third Sale-Offer Data (103), and the other Sale-Offer Data (104), respectively, using data according to A, B, C, D, E as part of the decision-making process.
At least one of the First Electronic Devices (11) receives Purchase-Offer Data from the input of the First Purchase-Offer Data (401), the Second Purchase-Offer Data (402), the Third Purchase-Offer Data (403), and other Purchase-Offer Data (404), respectively, by selecting from any one of A, B, C, D, E, or combination thereof as part of the decision-making process. The First Electronic Device (11) will send sale offer that can be selected from input of the First Sale-Offer Data (101), the Second Sale-Offer Data (102), and the Third Sale-Offer Data (103), and other Sale-Offer Data (104), respectively, to a Central Processing Unit (30). The Central Processing Unit (30), when receiving the First Sale-Offer Data (101), the Second Sale-Offer Data (102), and the Third Sale-Offer Data (103), and other Sale-Offer Data (104), respectively, will forward data to at least one of the Second Electronic Devices (41) that can be selected from input of the First Purchase-Offer Data (401), the Second Purchase-Offer Data (402), the Third Purchase-Offer Data (403), and other Purchase-Offer Data (404), respectively,
wherein the First Sale-Offer Data (101), the Second Sale-Offer Data (102), and the Third Sale-Offer Data (103), and the other Sale-Offer Data (104), respectively, and the First Purchase-Offer Data (401), the Second Purchase-Offer Data (402), the Third Purchase-Offer Data (403), and the other Purchase-Offer Data (404), respectively, that communicate with each other via the First Electronic Device (11), the Central Processing Unit (30), and the Second Electronic Device (41) will confirm the matched offers, creating the first step of transaction (1).

4. The system and method for collecting asset or real estate data and real-time matching of sale offers and purchase offers possibility according to claim 1, wherein
the next step, the First Electronic Device (11) and the Second Electronic Device (41) will send data to each other and communicate with each other to ask for more details, and price negotiation, creating the second step of transaction (2),
then the next step, the Second Electronic Device (41) will transfer deposit through the website operating system and application realized by a Central Processing Unit (30), creating the third step of transaction (3),
then, the next step, the First Electronic Device (11) and the Second Electronic Device (41) will send data to each other and communicate with each other to find an agency (50) to inspect asset or real estate, creating the fourth step of transaction (4),
then, the next step, the selected agency (50) will be notified that they are selected as the agency to valuate and inspect assets or real estate by sending data from a Central Processing Unit (30) to Third Electronic Device (51), creating the fifth step of transaction (5),
then, the next step, the agency (50) will coordinate with the purchase offeror (42) and the sale offeror (12) via the Third Electronic Device (51) to manage legal documents and register with the Land Office and manage payment between sale offeror and purchase offeror, creating the sixth step of transaction (6).
